(19) United States
(12) Patent Application Publication
(10) Pub. No.: US 2006/0242296 A1
(43) Pub. Date: Oct. 26, 2006

(54) Method of adding new users to a web based portal server

(76) Inventors: Leamon M. Woolard, McKinney, TX (US); Norman P. Smith, Plano, TX (US); Matthew J. Linn, Plano, TX (US)

Correspondence Address: TEXAS INSTRUMENTS INCORPORATED, P O BOX 655474, M/S 3999, DALLAS, TX, 75265, US

(21) Appl. No.: 11/100,909

(22) Filed: Apr. 7, 2005

(51) Int. Cl. G06F 15/173

(52) U.S. Cl. 709/225

(57) ABSTRACT

A method of adding new user's to a web based portal server such as Microsoft SharePoint® by detecting a new user's request and interrogating the proper domain controllers to determine if the user has a single active directory domain account. Then completing the add user process with the proper active domain or using the active domain account.

### FIELD OF INVENTION

This invention relates to server based software for collaboration and more particularly to a method of adding new users to a portal server such as Microsoft's 2003 SharePoint® Portal server.

### BACKGROUND OF INVENTION

Microsoft Windows SharePoint® products and technologies facilitate collaboration within an organization. Using the combined collaboration features of Windows SharePoint®&, users in an organization can easily create, manage, and build their own collaborative Web sites and make them available through the organization. The portal server may be at a given location or may be several servers in many locations. User's then connect up to the portal server from different parts of the organization. These users may use new current Windows active directory domain but may have older Windows NT operating system domain. To use Microsoft SharePoint® with maximum effectiveness requires converting the entire organization or company to Microsoft latest active directory domain before deploying SharePoint®. When adding new user's to SharePoint® unskilled users manually test which domain they are on. This is a hit or miss method. Some do not have the latest domain and miss out.

### SUMMARY OF INVENTION

In accordance with one embodiment of the present invention a method is provided for detection a new user request and interrogating the proper domain controllers for the user's active domain. Then completing the add user's process with the proper active domain or using the active domain account.

### DESCRIPTION OF DRAWING

FIG. 1 is a diagram of the method according to one embodiment of the present invention.

### DESCRIPTION OF PREFERRED EMBODIMENT

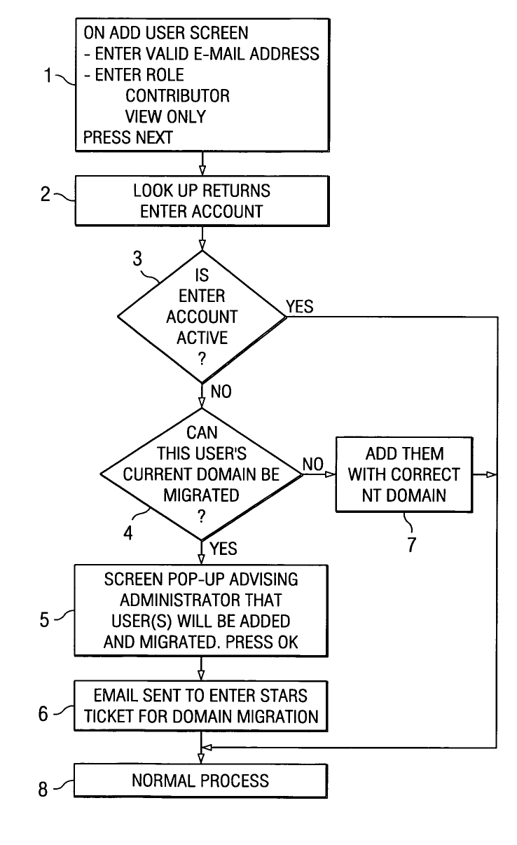

When a SharePoint site is set up the management at the site determines who get access to the site. Referring to FIG. 1 the SharePoint® provides to the user wanting access a screen for the user to enter a valid email address and enter the role the user may have in the organization such as such as read only or contributor. This is step 1.

The server intercepts this information, interrogates the proper domain controllers for the user's active domain and enters the entrance or ENT account and looks up in accounts listed to determine if they are in the active directory domain already. This is step 2.

The system then determines in step 3 if the ENT account is active. That is, they only have one account and it is in the active directory domain. If the answer in step 3 is “yes” then the access is granted for normal process. If they have only a NT domain account or both an NT and an active directory domain account this is a “no” and is registered as not having an active account in step 3.

If the answer is that they have both an NT account and an active directory domain account that can be flagged and handled separately or handled as a “no” in step 3.

If the answer is “no” at step 3 because the current account is an NT domain account, it is then determined at step 4 if that current old NT account domain can be migrated to the current active directory domain. It can also be used to disable the old NT domain account if it is determined that both an NT domain account and an active directory domain account is found.

If the migration decision is “yes” at step 4 the server sends pop-up information informing the owner of the site that the user will be added and migrated in step 5. In an automated logic path, the system determines if that site where the user has requested access can be migrated. In step 4, this can be an automated system where the system looks up a directory and determines where the user is located and determines if that site is able to be upgraded to support a single active directory domain. If that is so, the advisory pop-up screen is provided advising the administrator or owner of the site that the user's will be added and migrated. It may take, for example, three days to be completed.

A email is sent automatically to enter in Stars ticket reporting system for domain migration as indicated in step 6. This information goes to a group of support team people that take the information about this user and get that user converted. They make the necessary changes in the user's PC to be converted to the current active directory domain. When conversion is completed the ID of the user changes so the user logs into the system with the new ID. One of the ways the migration takes place is by calling the person to be added to the site and work with them to get their account corrected. They will have to go into the active directory domain system and install a new account for the person. Go into the old NT domain system and disable the existing old account.

If the user's current domain is NT domain and it can not be migrated as indicted as a “no” at step 4, the user is still admitted with their current NT domain with the limitations of that domain. There are features they cannot use.

Those skilled in the art will recognize that modifications and variations can be made without departing from the spirit and scope of the invention. Therefore, it is intended that this invention encompass all such variations and modifications as fall within the scope of the appended claims.

1. A method of adding new users to a web based portal server comprising the steps of:
detecting a new user's request and interrogating proper domain controllers for the user's active domain and
completing the adding of a new user with roper active domain or using the active domain account.

2. The method of claim 1 wherein the completing step includes determining if the use has a single current active directory account and, if not, determining if the user's current domain account be migrated.

3. The method of claim 2 wherein the completing step includes migrating the user's current domain account to proper active domain.

4. The method of claim 3 wherein if the user's current domain can not be migrated adding the user with the user's active domain.

5. The method of claim 3 wherein if the user's current domain account can be migrated generating a pop-up screen notifying the administration that the user will be added and migrated.

6. A method of adding new users to a web based Microsoft SharePoint® portal server comprising the steps of:
detecting a new user's request and interrogating proper domain controllers for determining if the user has a single active directory domain account and completing the adding of a new user using the active domain account if it has a single active directory domain account and if it does not completing the adding of a new user with a single migrated active directory domain and if it cannot be migrated using the current active domain.
